(19) United States
(12) Patent Application Publication
(10) Pub. No.: US 2013/0076630 A1
(43) Pub. Date: Mar. 28, 2013

(54) KEYSTROKE EVENT NOTIFICATION METHOD AND COMPUTER SYSTEM THEREOF

(71) Applicants: Chia-Wei Tseng, New Taipei City (TW); Kuan-Yu Kao, New Taipei City (TW)

(72) Inventors: Chia-Wei Tseng, New Taipei City (TW); Kuan-Yu Kao, New Taipei City (TW)

(73) Assignee: WISTRON CORPORATION, New Taipei City (TW)

(21) Appl. No.: 13/370,585

(22) Filed: Feb. 10, 2012

(30) Foreign Application Priority Data
Sep. 27, 2011 (TW) 100134870

(51) Int. Cl. G06F 3/02

(52) U.S. Cl. 345/168

(57) ABSTRACT

A method and a computer system for keystroke event notification are provided. The method includes a number of steps. A keyboard controller scans a number of keys contained in a keyboard. The keys include at least one pressure-sensitive key and at least two key-functions are assigned to each of the at least one pressure-sensitive key in response to a pressure applied on the pressure-sensitive key. When one of the pressure-sensitive keys is scanned by the keyboard controller, the keyboard controller measures the pressure applied on the pressure-sensitive key. The keyboard controller uses at least two pressure thresholds to determine a level of the measured pressure. The keyboard controller controls a storage device containing a source code of a basic input/output system (BIOS) to deliver a keystroke event on the basis of the determination result, so as to activate one of the key-functions of the pressure-sensitive key.

This application claims the benefit of Taiwan application Serial No. 100134870, filed Sep. 27, 2011, the subject matter of which is incorporated herein by reference.

### BACKGROUND OF THE INVENTION

1. Field of the Invention

The invention relates in general to a method and a computer system for keystroke event notification, and more particularly to a method using pressure-sensitive key and a computer system for keystroke event notification.

2. Description of the Related Art

As the computer and its applications become more and more popular, users have a need regarding how to input data to the computer. The research personnel have been dedicated to providing various input devices. Of the various types of input devices, keyboard is a main input device often used by the users. The user can input various types of data (such as letters, symbols, cursors, windows, system operation signals or various control signals) to the computer via a keyboard.

One method for increasing the data volume that can be inputted via a keyboard is achieved by increasing the number of keys contained in a keyboard. For example, some specific keys such as function keys are added to the keyboard. However, such method has operation problem due to the increase in the number of keys. For example, too many keys will make the keys too small to recognize or too far to reach, and the user will be bothered by remembering the functions of individual keys. Also, the cost of the keyboard will be increased.

Another method for increasing the data volume that can be inputted via a keyboard is achieved by changing the original function of the keys by some specific keys. That is, the original function of a key will change when the key is combined with a specific key. Such specific keys are also referred as composite keys or modifier keys. For example, the function key Fn with “Fn” printed thereon is a modifier key. When the function key Fn and some other function key (such as the F4 key) are pressed at the same time, the original function of the function key is modified and an alternate function is generated. However, it is indeed inconvenient for the user to press two keys at the same time.

Therefore, how to increase the data volume that can be inputted via a keyboard has become a prominent task for the industries.

### SUMMARY OF THE INVENTION

The invention is directed to a method and a computer system for keystroke event notification, the method of assigning different functions to a pressure-sensitive key in response to a pressure applied on the pressure-sensitive key increases the data volume that can be inputted via a keyboard.

According to one embodiment of the present invention, a keystroke event notification method is provided. The method includes the following steps. A keyboard controller scans a number of keys contained in a keyboard. The keys include at least one pressure-sensitive key and at least two key-functions are assigned to each of the at least one pressure-sensitive key in response to a pressure applied on the pressure-sensitive key. When the keyboard controller scans one of the pressure-sensitive keys, the keyboard controller measures the pressure applied on the pressure-sensitive key. The keyboard controller uses at least two pressure thresholds to determine a level of the measured pressure. The keyboard controller controls a storage device containing a source code of a basic input/output system (BIOS) to deliver a keystroke event on the basis of the determination result, so as to activate one of the key-functions of the pressure-sensitive key.

According to an alternate embodiment of the present invention, a computer system including a keyboard, a keyboard controller, and a storage device is provided. The keyboard comprises a number of keys. The keys include at least one pressure-sensitive key and at least two key-functions are assigned to each of the at least one pressure-sensitive key in response to a pressure applied on the pressure-sensitive key. The keyboard controller is operationally connected to the keyboard. The keyboard controller scans the keys. When the keyboard controller scans one of the pressure-sensitive keys, the keyboard controller measures the pressure applied on the pressure-sensitive key. The keyboard controller further uses at least two pressure thresholds to determine a level of the measured pressure. The storage device contains a source code of a basic input/output system (BIOS). The storage device is controlled by the keyboard controller to deliver a keystroke event on the basis of the determination result, so as to activate a corresponding key-function of the pressure-sensitive key.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 shows a flowchart of a keystroke event notification method according to an embodiment of the invention;

FIG. 2 shows an example of a computer system according to an embodiment of the invention;

FIG. 3 shows an example of a portion of the computer system of FIG. 2;

FIG. 4 shows an example of a scan period of a pressure-sensitive key;

FIG. 5 shows a portion of the scan period of FIG. 4; and

FIGS. 6A and 6B show an example of a detailed flowchart of the keystroke event notification method of FIG. 1.

### DETAILED DESCRIPTION OF THE INVENTION

A method and a computer system for keystroke event notification are disclosed below in a number of embodiments. In some embodiments, the method of assigning different functions to a pressure-sensitive key in response to a pressure applied on the pressure-sensitive key increases the data volume that can be inputted via a keyboard.

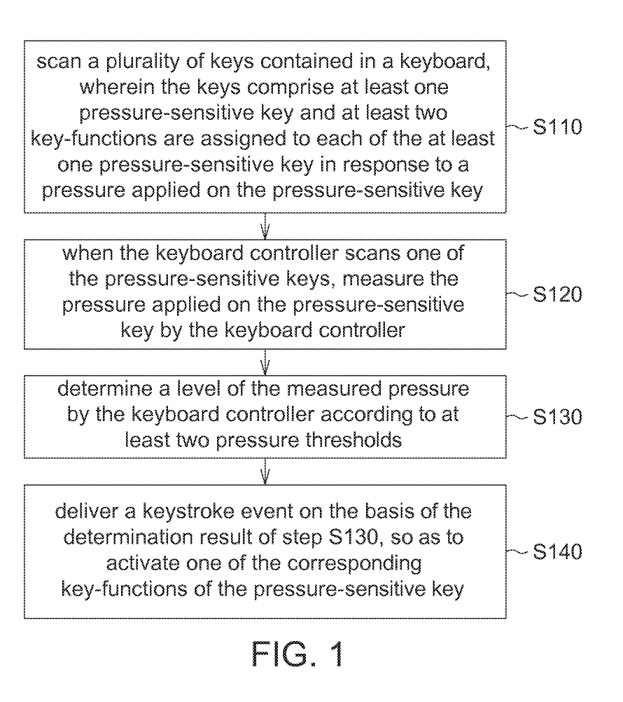

Referring to FIG. 1, a flowchart of a keystroke event notification method according to an embodiment of the invention is shown. The notification method includes a number of steps. In step S110, the keyboard controller scans a number of keys contained in a keyboard. The keys include at least one pressure-sensitive key and at least two key-functions are assigned to each of the at least one pressure-sensitive key in response to a pressure applied on the pressure-sensitive key. In step S120, when the keyboard controller scans one of the pressure-sensitive keys, the keyboard controller measures the pressure applied on the pressure-sensitive key. In step S130, the keyboard controller uses at least two pressure thresholds to determine a level of the measured pressure. In step S140, the keyboard controller controls the storage device containing a source code of a basic input/output system (BIOS) to deliver a keystroke event on the basis of the determination result, so as to activate a corresponding key-function of the pressure-sensitive key.

By dividing the pressure applied on the pressure-sensitive key into different levels, at least more than two functions can be assigned to a pressure-sensitive key. A corresponding key-function of the pressure-sensitive key can be activated according to the level of the pressure. Thus, the pressure-sensitive key can generate different functions according to the level of the applied pressure thereto, and the data volume that can be inputted via a keyboard is increased accordingly.

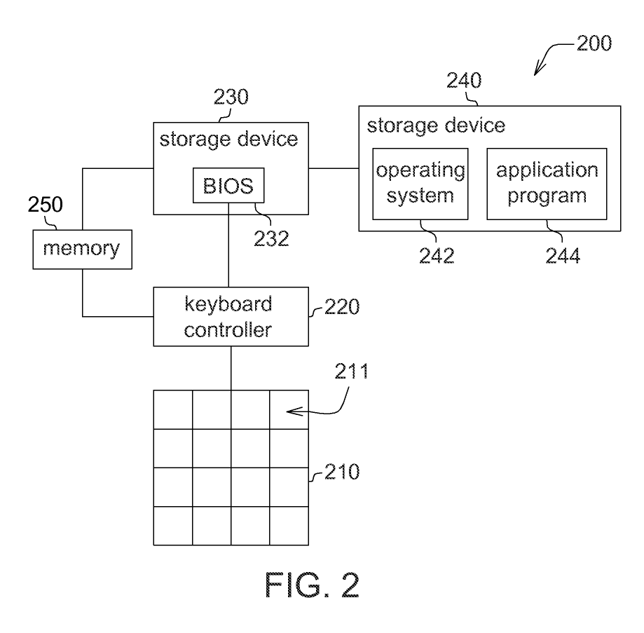

Referring to FIG. 2, an example of a computer system according to an embodiment of the invention is shown. The computer system 200 is such as a portable computer, a personal computer, a notebook computer, a server computer, an information processing system, or other device with processor and/or memory. The computer system 200 at least includes a keyboard 210, a keyboard controller 220, a storage device 230, a storage device 240, and a memory 250.

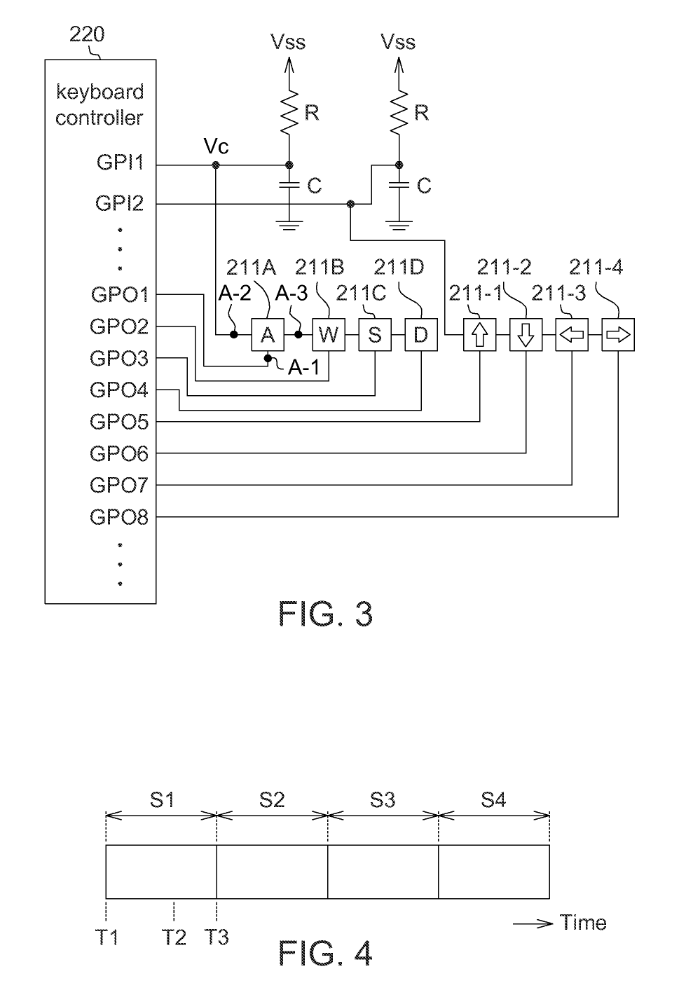

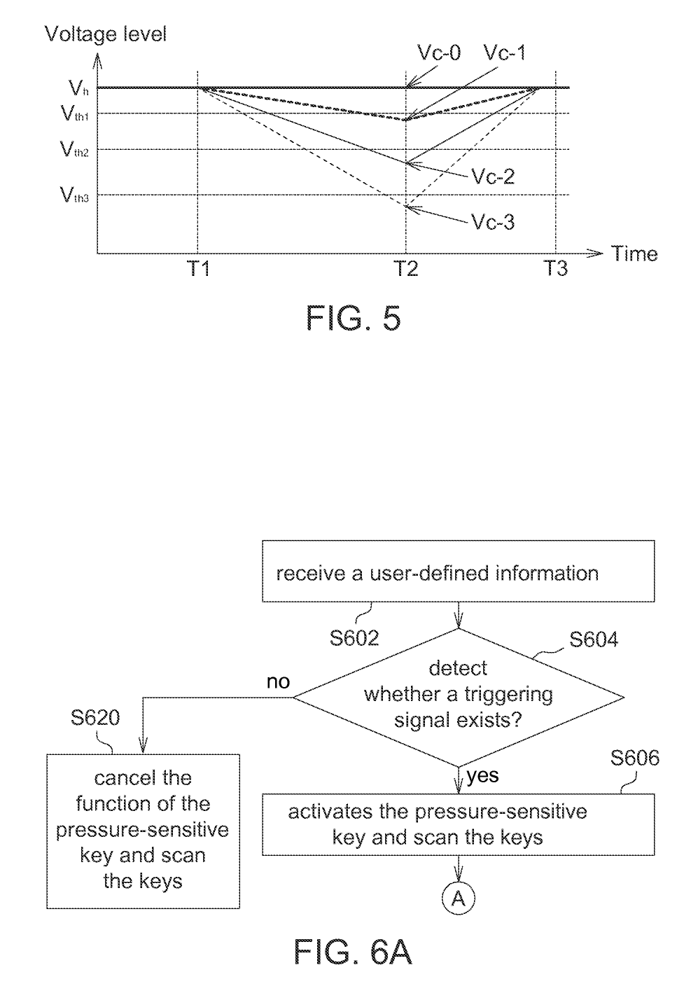

Referring to FIG. 2, FIG. 3, FIG. 4, and FIG. 5. FIG. 3 shows an example of a portion of the computer system of FIG. 2. FIG. 4 shows an example of a scan period of a pressure-sensitive key. FIG. 5 shows a portion of the scan period of FIG. 4.

The keyboard 210 includes a number of keys 211. The keys 211 include at least one pressure-sensitive key. For example, as indicated in FIG. 3, the keys 211 may include a set of pressure-sensitive keys 211A, 211W, 211S, and 211D or another set of pressure-sensitive keys 211-1, 211-2, 211-3, and 211-4. The pressure-sensitive keys 211A, 211W, 211S, and 211D are such as serially connected one by one. Each pressure-sensitive key is such as a tri-end element. Let the pressure-sensitive key 211A be taken for example, the pressure-sensitive key 211 has a control end A-1 and two other ends A-2 and A-3. When the control end A-1 of the pressure-sensitive key 211A is enabled, the pressure-sensitive key 211A changes the resistances of the two ends A-2 and A-3 according to the magnitude of the pressure applied thereon. When the control end A-1 of the pressure-sensitive key 211A is disabled, two ends A-2 and A-3 of the pressure-sensitive key 211A are in a short-circuited state with low resistance.

At least two key-functions are assigned to each pressure-sensitive key contained in the keyboard 210 in response to a pressure applied on the pressure-sensitive key. For example, as indicated in FIG. 3, three key-functions are assigned to the pressure-sensitive key A in response to heavy pressure, moderate pressure and light pressure respectively. However, the invention is not limited thereto, and the number of key-functions assigned to a pressure-sensitive key can be determined according to the needs.

The keyboard controller 220 is operationally connected to the keyboard 210. The keyboard controller 220, connected to the keyboard 210 such as via a connector, such as a Deutsche Industrie Norm (DIN) connector, a PS/2 connector, a universal serial bus (USB) connector, or an equivalent connector. The keyboard controller 220 can be realized by such as an embedded controller containing a source code of an embedded system.

The keyboard controller 220 scans the keys 211. The keyboard controller 220 such as sequentially scans the keys 211. For example, as indicated in FIG. 4, the keyboard controller 220 sequentially scans the pressure-sensitive keys 211A, 211W, 211S, and 211D in periods S1 to S4 respectively.

The keyboard controller 220 measures the pressure applied on the pressure-sensitive key on scanning one of the pressure-sensitive keys. The keyboard controller 220 measures the pressure applied on the pressure-sensitive key according to the resistance varying with the pressure applied on the pressure-sensitive key and the charged current/discharged current of the capacitor.

The process of measuring the pressure applied on the pressure-sensitive key by the keyboard controller 220 in the course of scanning the pressure-sensitive keys is disclosed below. As indicated in FIG. 3 and FIG. 5, before the scan period S1 of pressure-sensitive key 211A, the power Vss charges the capacitor C connected to the pressure-sensitive key 211A via a resistor R for enabling the voltage value Vc to reach a rated value Vh. In the scan period S1 of the pressure-sensitive key 211A, the keyboard controller 220 reads the voltage Vc of the capacitor via an analog-to-digital pin GPI1.

At time point T1, the keyboard controller 220 enables the control end A-1 of the pressure-sensitive key 211A for allowing the voltage Vc of the capacitor C to vary with the pressure-sensitive key 211A. The keyboard controller 220 such as outputs a low-level signal via an output pin GPO1 to enable the control end A-1 of the pressure-sensitive key 211A. When the control end A-1 of the pressure-sensitive key 211A is enabled, the two ends A-2 and A-3 of the pressure-sensitive key 211A are equivalent to a resistor varying with the pressure applied on the pressure-sensitive key 211A. Thus, the charged current/discharged current of the capacitor C flows to the keyboard controller 220 via the resistor, and the voltage value Vc is decreased correspondingly. In the present example, the larger the pressure applied on the pressure-sensitive key 211A, the larger the resistance, and the lower the voltage Vc is after the capacitor C is discharged.

At the time point T2 following the time point T1, the keyboard controller 220 measures the voltage Vc of the capacitor C to represent the pressure applied on the pressure-sensitive key 211A. In other words, since the capacitor C is discharged via the variable resistor of the pressure-sensitive key 211A, the level of the voltage Vc after the current is discharged is related to the pressure applied on the pressure-sensitive key 211A. For example, as indicated in FIG. 5, if the voltage Vc becomes voltage value Vc-0 after the current is discharged, this implies that the pressure applied on the pressure-sensitive key 211A is very low or near zero. If the voltage Vc becomes voltage value Vc-1 after the current is discharged, this implies that the pressure applied on the pressure-sensitive key 211A is high. Likewise, the voltage value Vc-2 and the voltage value Vc-3 represent larger pressure applied on the pressure-sensitive key.

At time point T2, the keyboard controller 220 disables the control end A-1 of the pressure-sensitive key 211A to avoid the voltage Vc of the capacitor C varying with the pressure applied on the pressure applied on the pressure-sensitive key 211A. The keyboard controller 220 outputs a light-level signal via an output pin GPO1 to disable the control end A-1 of the pressure-sensitive key 211A. When the control end A-1 of the pressure-sensitive key 211A is disabled, the two ends A-2 and A-3 of the pressure-sensitive key 211A are in a short-circuited state with low resistance. Thus, the discharged current of the capacitor C stops flowing to the keyboard controller 220 via the two ends A-2 and A-3 of the pressure-sensitive key 211A.

In some embodiments, the keyboard controller 220 uses at least two pressure thresholds to determine a level of the measured pressure. For example, as indicated in FIG. 5, the keyboard controller 220 uses three pressure thresholds Vth1 to Vth3 (such as voltage values) to determine the level of the measured pressure such as the first level, the second level, the third level, or the fourth level in a descending order. If the measured voltage Vc is Vc-0 being larger than the largest voltage threshold Vth1, this implies that the pressure applied on the pressure-sensitive key 211A belongs the first level. If the measured voltage Vc is Vc-1 ranging between voltage thresholds Vth1 and Vth2, this implies that the pressure applied on the pressure-sensitive key 211A belongs the second level. If the measured voltage Vc is Vc-2 ranging between voltage thresholds Vth2 and Vth3, this implies that the pressure applied on the pressure-sensitive key 211A belongs the third level. If the measured voltage Vc is Vc-3 being smaller than the smallest voltage threshold Vth3, this implies that the pressure applied on the pressure-sensitive key 211A belongs the fourth level.

Three pressure thresholds are used as an exemplification of the invention. However, the invention is not limited to the above exemplification. In other embodiment, the keyboard controller 220 can define three or more than three pressure levels with two or more than two pressure thresholds, so as to define at least three states (the state in which the key is not pressed, the state in which the key is moderately pressed and the state in which the key is heavily pressed respectively) of the pressure-sensitive key (not being pressed, being moderately pressed, and being heavily pressed respectively). Thus, two different key-functions can be defined according to two pressing states of the pressure-sensitive key (excluding the state in which the key is not pressed). Thus, the data volume that can be inputted via a keyboard is increased.

In some embodiments, with respect to each pressure level, the keyboard controller 220 can store a corresponding code or digit such as 1, 2, 3, or other user-defined digit in the memory 250 and notify the storage device 230 of the BIOS 232 to read the memory 250. In an alternate embodiment, the keyboard controller 220 can directly store the read voltage Vc to the memory 250 and notify the storage device 230 of the BIOS 232 to read memory 250. Then, the storage device 230 uses at least two pressure thresholds to determine which level the read voltage to.

Moreover, the keyboard controller 220 waits for a period of time starting from the time point T2, such as starting from the time point T2 to the time point T3, for allowing the voltage Vc of the capacitor C to return to its initial value. In practical application, the required waiting time can be obtained from the time constants of the capacitor C and the resistor R. After the voltage Vc of the capacitor C to return to its initial value, the keyboard controller 200 scans a next pressure-sensitive key and measures the voltage Vc of the capacitor C again to represent the pressure applied on the pressure-sensitive key.

Referring to FIG. 2, the storage device 230 contains a source code of the BIOS 232. The storage device 230 is controlled by the keyboard controller 220 to deliver a keystroke event on the basis of the determination result of the pressure thresholds, so as to activate a corresponding key-function of the pressure-sensitive key.

In some embodiments, the storage device 230 delivers the keystroke event to another storage device 240, which has a source code of an operating system 242 and a source code of an application program 244. The keystroke event is such as a windows management instrumentation (WMI) event. The keystroke event is delivered to the application program 244 via the operating system 242, such that the application program 244 activates a corresponding key-function.

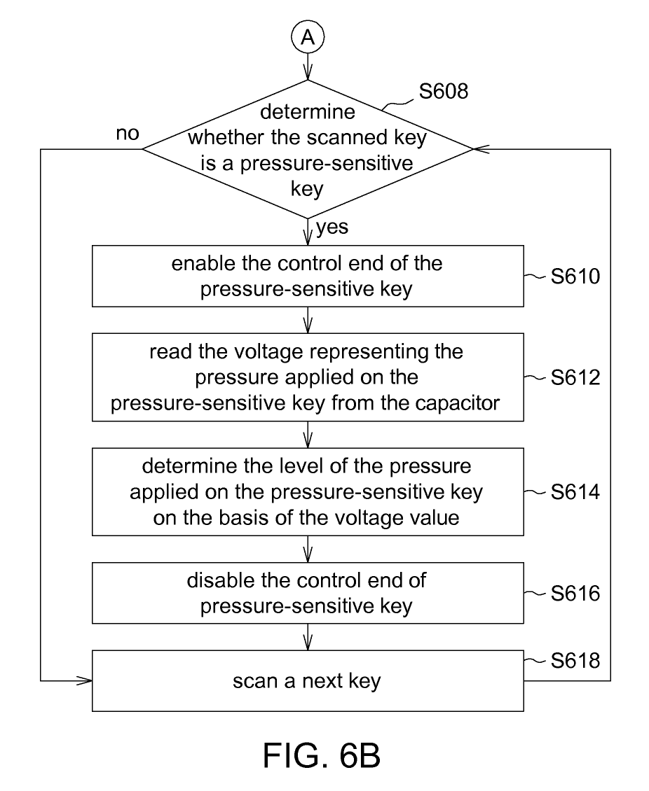

Referring to FIGS. 6A and 6B, an example of a detailed flowchart of the keystroke event notification method of FIG. 1 is shown.

In step S602, the computer system 200 receives a user-defined information. The user-definable information, such as the information for setting the function of one of the pressure-sensitive keys, can be sent to the storage device 230 of a BIOS via the communication interface 242. Then, the storage device 230 delivers the event to the keyboard controller 220 to inform the user-definable key-function assigned to the pressure-sensitive key. Thus, the key-function required for the user to define the function is provided, and the convenience is further improved.

In step S604, the keyboard controller 220 detects whether a triggering signal exists. The triggering signal, such as a signal emitted from the keyboard 210, activates the pressure-sensitive key. The triggering signal is such as a keystroke signal of one single key 211 or a combination of some of the keys 211. If the keyboard controller 220 does not detect any triggering signal, then the method proceeds to step S620, the keyboard controller 220 cancels the function of the pressure-sensitive key and scans the keys. If the keyboard controller 220 detects a triggering signal, then the method proceeds to step S606.

In step S606, the keyboard controller 220 activates the pressure-sensitive key and scans the keys 211.

In step S608, the keyboard controller 220 determines whether the scanned key is a pressure-sensitive key. If the scanned key is a pressure-sensitive key, then the method proceeds to step S610. If the scanned key is not a pressure-sensitive key, then the method proceeds to step S618.

In step S610, the keyboard controller 220 enables the control end of the pressure-sensitive key.

In step S612, the keyboard controller 220 reads the voltage representing the pressure applied on the pressure-sensitive key from the capacitor.

In step S614, the keyboard controller 220 determines the level of the pressure applied on the pressure-sensitive key on the basis of the voltage value.

In step S616, the keyboard controller 220 disables the control end of pressure-sensitive key.

In step S618, the keyboard controller 220 scans a next key. Following step S618, the method returns to step S608.

In some exemplary applications, the method and the computer system for keystroke event notification are such as used in computer games, and the function of a pressure-sensitive key may include three functions namely, walking, brisk walking, and running. In some exemplary applications, the method and the computer system for keystroke event notification are such as used in the adjustment of the volume of the sound or the brightness of the panel such that different pressure levels correspond to different levels of the sound or brightness. However, the invention is not limited to above exemplifications, and anyone who is skilled in the technology of the method and the computer system for keystroke event notification of the invention will understand various implementations in practical application.

According to the method and the computer system for keystroke event notification disclosed in the above embodiments of the invention, the method of assigning different functions to a pressure-sensitive key in response to a pressure applied on the pressure-sensitive key increases the data volume that can be inputted via a keyboard. In comparison to an ordinary keyboard in which one key normally has two states, (the state in which the key is pressed and the state in which the key is not pressed), the measurement of the pressure applied on the key enables one pressure-sensitive key to have at least three states, (the state in which the key is not pressed, the state in which the key is moderately pressed and the state in which the key is heavily pressed respectively). Thus, two different key-functions can be defined according to two pressing states of the pressure-sensitive key (excluding the state in which the key is not pressed). Thus, the data volume that can be inputted via a keyboard is increased.

While the invention has been described by way of example and in terms of the preferred embodiment (s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A keystroke event notification method, comprising:
scanning a plurality of keys contained in a keyboard by a keyboard controller, wherein the keys comprise at least one pressure-sensitive key and at least two key-functions are assigned to each of the at least one pressure-sensitive key in response to a pressure applied on the pressure-sensitive key;
measuring the pressure applied on one of the pressure-sensitive key by the keyboard controller while the pressure-sensitive key is scanned by the keyboard controller;
determining a level of the measured pressure by the keyboard controller according to at least two pressure thresholds;
controlling a storage device containing a source code of a basic input/output system (BIOS) by the keyboard controller to deliver a keystroke event on the basis of the determination result, so as to activate one of the key-functions of the pressure-sensitive key.

2. The method according to claim 1, wherein the step of measuring the pressure applied on the pressure-sensitive key by the keyboard controller comprises:
enabling a control end of the pressure-sensitive key by the keyboard controller at a first time point for allowing the voltage of a capacitor connected to the pressure-sensitive key to vary with the pressure applied on the pressure-sensitive key.

3. The method according to claim 2, wherein the step of measuring the pressure applied on the pressure-sensitive key by the keyboard controller further comprises:
measuring the voltage of the capacitor by the keyboard controller at a second time point following the first time point to represent the pressure applied on the pressure-sensitive key.

4. The method according to claim 3, wherein the step of measuring the pressure applied on the pressure-sensitive key by the keyboard controller further comprises:
disabling the control end of the pressure-sensitive key by the keyboard controller at the second time point to avoid the voltage of the capacitor varying with the pressure applied on the pressure-sensitive key.

5. The method according to claim 4, wherein the step of measuring the pressure applied on the pressure-sensitive key by the keyboard controller further comprises:
waiting for a period of time starting from the second time point by the keyboard controller for allowing the voltage of the capacitor to return to its initial value.

6. The method according to claim 1, wherein one of the key-functions is a user-definable key-function.

7. The method according to claim 1, further comprising:
detecting a triggering signal by the keyboard controller;
wherein, the keyboard controller enters the scanning step when the triggering signal is detected.

8. The method according to claim 7, wherein the triggering signal is emitted from the keyboard.

9. A computer system, comprising:
a keyboard comprising a plurality of keys, wherein the keys comprise at least one pressure-sensitive key and at least two key-functions are assigned to each of the at least one pressure-sensitive key in response to a pressure applied on the pressure-sensitive key;
a keyboard controller operationally connected to the keyboard to scan the keys, wherein, when the keyboard controller scans one of the pressure-sensitive keys, the keyboard controller measures the pressure applied on the pressure-sensitive key, and further uses at least two pressure thresholds to determine a level of the measured pressure; and
a storage device containing a source code of a basic input/output system (BIOS), wherein the storage device is controlled by the keyboard controller to deliver a keystroke event on the basis of the determination result, so as to activate one of the key-functions of the pressure-sensitive key.

10. The computer system according to claim 9, wherein when the keyboard controller measures the pressure applied on the pressure-sensitive key, the keyboard controller enables a control end of the pressure-sensitive key at a first time point for allowing the voltage of a capacitor connected to the pressure-sensitive key to vary with the pressure applied on the pressure-sensitive key.

11. The computer system according to claim 10, wherein when the keyboard controller measures the pressure applied on the pressure-sensitive key, the keyboard controller further measures the voltage of the capacitor to represent the pressure applied on the pressure-sensitive key at a second time point following the first time point.

12. The computer system according to claim 11, wherein when the keyboard controller measures the pressure applied on the pressure-sensitive key, the keyboard controller further disables the control end of the pressure-sensitive key at the second time point to avoid the voltage of the capacitor varying with the pressure applied on the pressure-sensitive key.

13. The computer system according to claim 12, wherein when the keyboard controller measures the pressure applied on the pressure-sensitive key, the keyboard controller further waits for a period of time starting from the second time point for allowing the voltage of the capacitor to return to its initial value.

14. The computer system according to claim 9, wherein one of the key-functions is a user-definable key-function.

15. The computer system according to claim 9, wherein the keyboard controller further scans the keys when a triggering signal is detected.

16. The computer system according to claim 15, wherein the triggering signal is emitted from the keyboard.
